(19) United States
(12) Patent Application Publication
(10) Pub. No.: US 2013/0152018 A1
(43) Pub. Date: Jun. 13, 2013

(54) ELECTRONIC DEVICE WITH TOUCH SCREEN AND PAGE PROCESSING METHOD THEREOF

(71) Applicants: CHIA-HAO CHUANG, Tu-Cheng (TW); CHIH-SAN CHIANG, Tu-Cheng (TW); DA-JUN XIONG, Shenzhen City (CN); YAO-HUI ZENG, Shenzhen City (CN); XUE-TAO TAN, Shenzhen City (CN); SHENG-CHU LU, Shenzhen City (CN)

(72) Inventors: CHIA-HAO CHUANG, Tu-Cheng (TW); CHIH-SAN CHIANG, Tu-Cheng (TW); DA-JUN XIONG, Shenzhen City (CN); YAO-HUI ZENG, Shenzhen City (CN); XUE-TAO TAN, Shenzhen City (CN); SHENG-CHU LU, Shenzhen City (CN)

(21) Appl. No.: 13/665,942

(22) Filed: Nov. 1, 2012

(30) Foreign Application Priority Data
Dec. 12, 2011 (CN) 201110411718.6

(51) Int. Cl. G06F 3/048

(52) U.S. Cl. 715/823

(57) ABSTRACT

A page processing method for an electronic device is provided. The method includes the steps of: displaying a first cube consisting of a plurality of stacked layers, the stacked layers comprising a top layer displaying a current active icon group and remaining layers beneath the top layer associated with corresponding inactive icon groups; displaying a second cube consisting of a plurality of stacked layers, the stacked layers each associated with a inactive icon group; determining the touched region; determining the type of the touch by the user; retrieving a target page stored in the storage unit or creating a target page; creating at least one new icon group; and displaying the target page on the page display region, and updating the icon groups on the first and second cubes. An electronic device using the page processing method is also provided.

### BACKGROUND

1. Technical Field

The present disclosure relates to an electronic device with a touch screen and a page processing method thereof.

2. Description of Related Art

Electronic devices with touch screens, e.g., mobile phones, digital photo frames, electronic readers (e-readers), are capable of storing and displaying electronic documents (e.g., digital images and digital texts). A user may select a page via touches on the touch screen of the electronic device. For example, the user can flip to a previous page or to a next page via sliding rightward or leftward on the displayed page. However, if the target page is far away from the displayed page, that is, there are a number of pages between the target page and the displayed page, a number of sliding operations must be applied on the touch screen to flip to the target page, which is rigid and not user-friendly enough.

Therefore, what is needed is an electronic device and a page processing method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a page processing method thereof. Moreover, in the drawings, like reference numerals designate corresponding sections throughout the several views.

FIG. 1 is a block diagram of an electronic device in accordance with an exemplary embodiment.

FIG. 2 is a function table stored in the electronic device of FIG. 1, which records the relationships between the touch regions of the touches, a number of types of touches and a number of page processing functions on the page display region.

FIGS. 3-7 are a number of schematic diagrams of the electronic device of FIG. 1, showing the page processing effects, in accordance with an exemplary embodiment.

FIG. 8 is a flowchart of a page processing method for electronic devices, such as the one of FIG. 1, in accordance with the exemplary embodiment.

### DETAILED DESCRIPTION

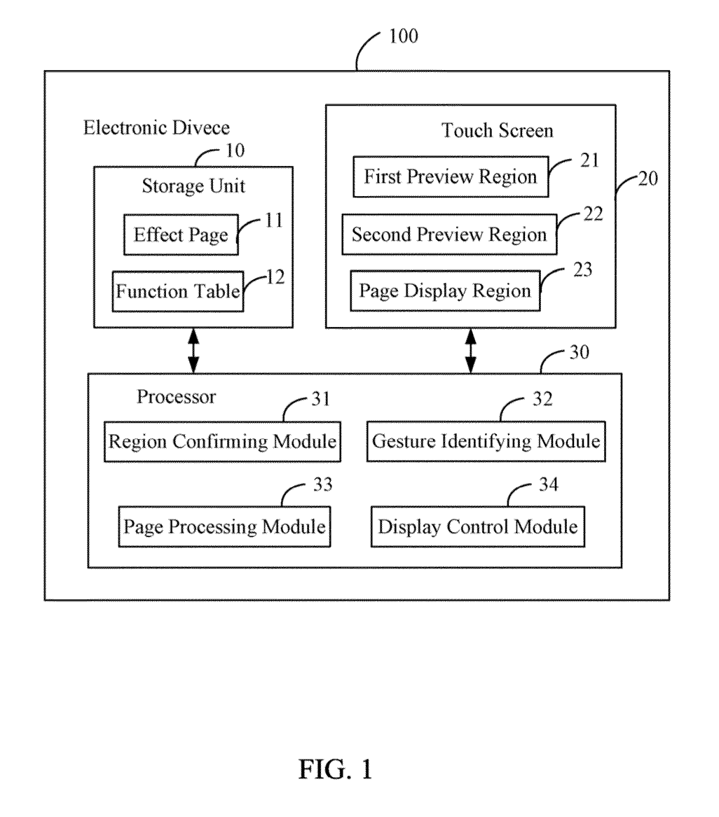

Referring to FIG. 1, an electronic device 100 is disclosed as an exemplary embodiment. The electronic device 100 can flip to a target page quickly and accurately in response to a user's touch operation. The electronic device 100 is a mobile phone. In alternative embodiments, the electronic device 100 can be other electronic devices having a touch screen, such as an electronic reader, a tablet, a digital phone frame or the like.

The electronic device 100 includes a storage unit 10, a touch screen 20, and a processor 30. The storage unit 10 stores a plurality of electronic files and an effect page 11 reflecting how the pages can be moved.

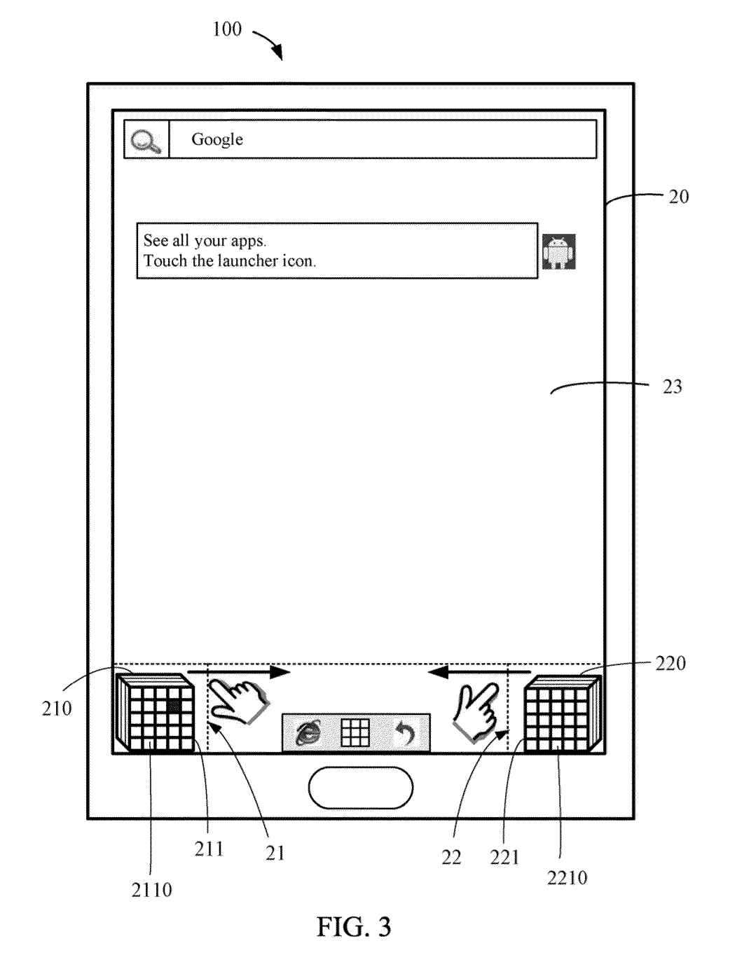

The touch screen 20 generates signals in response to user's touch operation applied on the touch screen 20. Referring to FIGS. 1 and 3, the touch screen 20 displays a page in response to a user's operation. The displayed page includes a first preview region 21, a second preview region 22, and a page display region 23.

In this embodiment, the first preview region 21 displays a cube 210 consisting of a plurality of stacked layers. The stacked layers include a top layer displaying a currently active icon group 211 and remaining layers beneath the top layer associated with corresponding inactive icon groups. Each icon represents and associates to a page.

In the embodiment, a page referred to in this disclosure can be a page of an electronic file, or an icon interface including a number of icons. For example, the page can be a major interface of the electronic device 100. The icon associated with the displayed currently displayed page on the touch screen 20 is marked with black, that is, the icon is infilled with black color. In an alternative embodiment, the icon associated with the displayed currently displayed page on the touch screen 20 can be marked with other colors or be highlighted in other manners.

The second preview region 22 displays a cube 220 consisting of a number of stacked layers. Each of the stacked layers associates with a inactive icon group. Each of the active and inactive icon groups includes a number of icons arranged in an array and associated with a number of corresponding adjacent pages, and the currently active icon group 211 includes a marked icon associated with a currently displayed page and a number of unmarked icons associated with a number of undisplayed pages adjacent to the currently displayed page. The number of the boxes or squares of each icon group 221 is at least equal to the number of the adjacent pages associated with the icon group 221. In an alternative embodiment, the page numbers can be disadjacent. The icon groups displayed on the first preview region 21 and the second preview region 22 represent all of the pages of an electronic file.

The page display region 23 is a larger region than the first and second preview regions 21, 22. The page display region 23 displays an icon group and/or a page selected by the user. The page display region 23 can generate signals in response to user's touch.

In this embodiment, when the electronic device 100 is used for viewing pages, the touch screen 20 constantly displays the first preview region 21, the second preview region 22, and the page display region 23. The first preview region 21 is located at the bottom left of the touch screen 20, and the second preview region 22 is located at the bottom right of the touch screen 20. Following a change of the currently displayed page, the icons of the first preview region 21 make a corresponding change. In other words, the displayed uppermost icon group 211 on the cube displayed on the first preview region 21 includes the icon associated with the currently displayed page (infilled with black) and a group of icons associated with the adjacent pages which are adjacent to the displayed currently displayed page. In this embodiment, each icon group of the first and second preview regions 21, 22 includes 25 icons respectively associated with 25 pages. In other embodiments, the number of the icons included in each of the icon groups can be predefined according to actual need.

The processor 30 includes a region confirming module 31, a gesture identifying module 32, a page processing module 33, and a display control module 34. When the electronic device 100 is powered on, the touch screen 20 displays a default user interface or displays a page of an electronic file in response to user's operation. The region confirming module 31 is configured to determine which region of the touch screen 20 has been touched by the user. That is, the region confirming module 31 determines whether a touch event occurs on the first preview region 21, the second preview region 22, or the page display region 23. The region confirming module 31 further transmits the result of determination to the gesture identifying module 32 and the page display module 33.

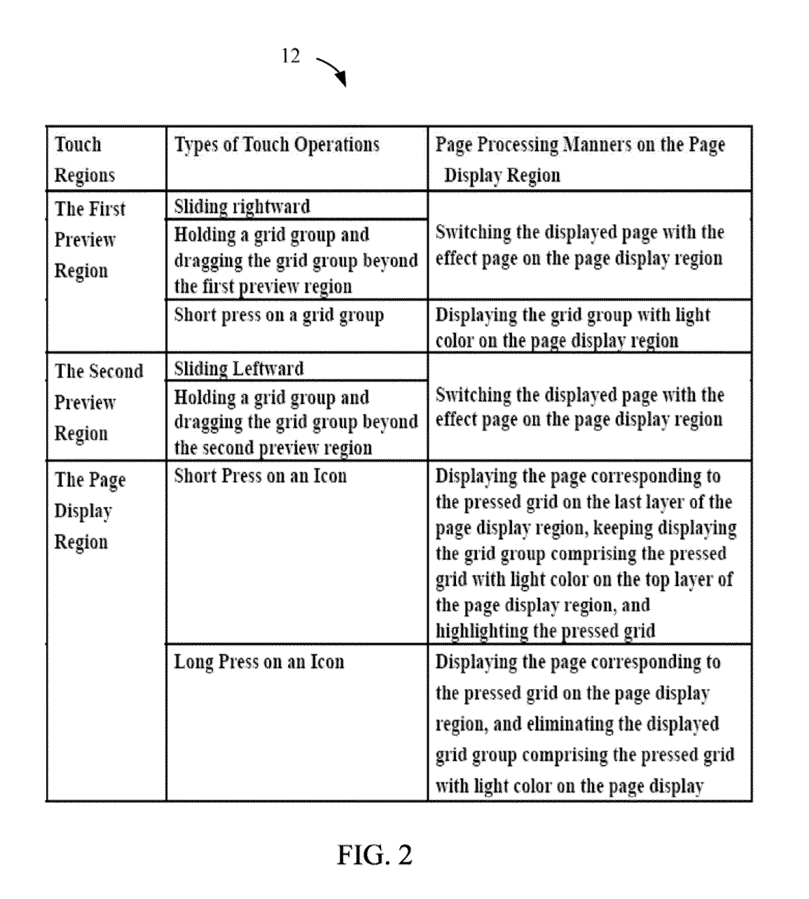

The gesture identifying module 32 determines whether the touch by the user corresponds to a predetermined type of touch operation, and transmits this determination to the page processing module 33. Referring to FIGS. 1 and 2, the storage unit 10 further stores a function table 12 recording relationships between the touch regions of the touches, a number of types of touches and a number of page processing functions on the page display region 23. The predetermined types of touches applied on the first preview region 21 are selected from the group consisting of: sliding rightward, holding an icon group and dragging the icon group out of the first preview region 21, and a short pressing of an icon group by a fingertip. The predetermined types of touches applied on the second preview region 22 are selected from the group consisting of: sliding leftward, and holding an icon group and dragging the icon group out of the second preview region 22. When the page display region 23 displays an icon group, the predetermined types of touches applied on the page display region 23 are selected from the group consisting of: a short pressing on an icon of an icon group, and a long pressing on an icon of an icon group.

The page processing module 33 determines a page processing function on the page display region 3 according to the determined results transmitted from the region confirming module 31 and the gesture identifying module 32 and the function table 12 stored in the storage unit 10. The page processing functions are applied on the page display region 23 and are determined according to the touch region of the touch operation, the type of the touch operation, and the function table 12. Referring to FIG. 2, the page processing functions are described as follows.

When the touch by the user applied on the first preview region 21 is sliding rightward, or holding an icon group and dragging the icon group beyond the first preview region 21, the corresponding page processing manner is to exchange the displayed page for the effect page 11 on the page display region 23. When the touch by the user applied on the first preview region 21 is a short pressing on an icon group, the corresponding page processing manner is to display the icon group overlapping the currently displayed page on the page display region 23.

When the touch by the user applied on the second preview region 22, is sliding leftward or holding an icon group and dragging the icon group beyond the second preview region 22, the corresponding page processing manner is to exchange the displayed page for the effect page 11 on the page display region 23.

When the touch by the user applied on the page display region 23 is a short pressing on an icon of an icon group, the corresponding page processing manner is to display the page associated with the icon under the icon group on the page display region 23, and to highlight the icon. When the touch of the user applied on the page display region 23 is a long pressing on an icon of an icon group, the corresponding page processing manner is to display the page associated with the icon on the page display region 23, and at the same time, cancel the display of the icon group on the page display region 23, that is, only the page associated with the icon is displayed on the page display region 23, and the icon group including the icon is no longer displayed on the page display region 23.

The page processing module 33 retrieves a target page stored in the storage unit 10 or creates a target page according to the determined page processing manner. The target page will be displayed on the page display region 23. The full detail of the page processing functions will be described later.

The page processing module 33 also creates a new icon group to-be-displayed on the first preview region 21 and/or the second preview region 22 according to the target page. That is, the page processing module 33 creates a first new icon group to be displayed on the top of the cube 210 displayed on the first preview region 21 and/or creates a second new icon group to be displayed on the top of the cube 220 displayed on the second preview region 22. The first new icon group includes a number of icons associated with the target page and a number of adjacent pages adjacent to the target page. The second new icon group includes a number of icons associated with a group of adjacent pages next following the group of adjacent pages associated with the icons included in the first new icon group. In the embodiment, the information of each page is displayed on the corresponding icon of the generated icon group. The information can be the page number of the page.

The display control module 34 controls the display of the target page retrieved or created by the page processing module 33 on the page display region 23, and controls the display of the new icon group created by the page processing module 33 on the page first preview region 21 and/or the second preview region 22.

Referring to FIGS. 3-7, a number of schematic diagrams of the user interface of the electronic device 100 showing the effects of the page processing are illustrated. After an electronic file is opened, the pages of the electronic file are divided into two groups of pages by the electronic device 100. The icon group associated with one of the two groups of pages is displayed on the first preview region 21, and the icon group associated with the other group of pages is displayed on the second preview region 22. Referring to FIG. 3, for example, the electronic file has 200 pages, the cube 210 displayed on the first preview region 21 includes the icon groups including the icons associated with the first 100 pages, and the cube 220 displayed on the second preview region 22 also includes the icon groups including the icons associated with the last 100 pages. As stated above, in this embodiment, each icon group includes 25 icons, thus, the cube 210 includes four stacking icon groups, the cube 220 also includes four stacking icon groups, and each icon group corresponds to 25 adjacent pages.

When the region confirming module 31 confirms a user touch on the first preview region 21, and the gesture identifying module 32 identifies that the type of the touch is sliding rightward, or holding an icon group and dragging the icon group out of the first preview region 21, that is, the user wants to move the current active icon group 211 displayed on the first preview region 21 onto the second preview region 22. Then, the page processing module 33 determines that the corresponding page processing function is to exchange the displayed page with the effect page 11 on the page display region 23, all according to the confirmed result, the identified result, and the function table 12. The page processing module 33 retrieves the effect page 11 stored in the storage unit 10, and creates a new active icon group 211a including a group of icons 2110a associated with a number of adjacent pages.

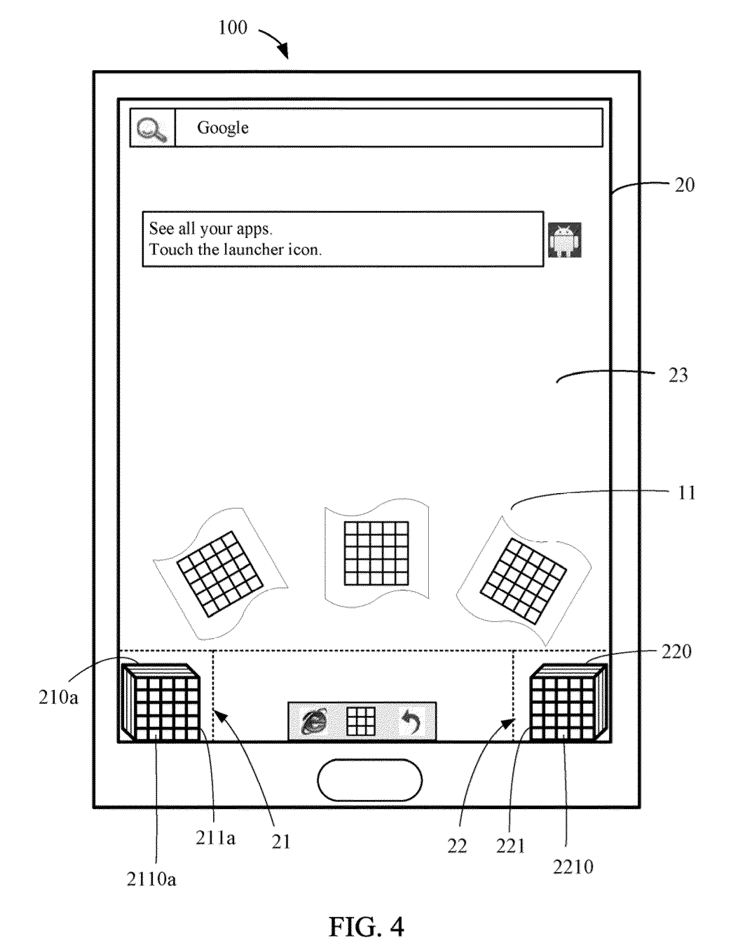

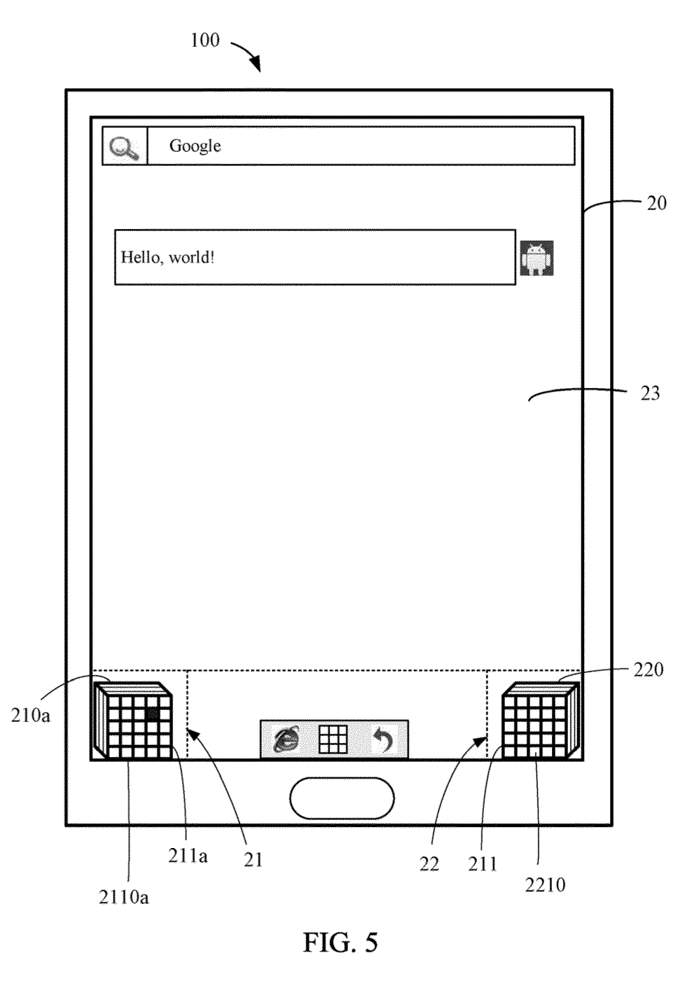

Referring to FIG. 4, the effective page 11 is displayed on the page display region 23, and the cube 210a with the icon group 211a on the top is displayed on the first preview region 21. When the icon group 211 is moved to the second preview region 22 (referring to FIG. 5) the icon group 211 is displayed on the top of the second preview region 22, and the page associated with an icon of the current active icon group 211a is displayed on the page display region 23. Fox example, the displayed page can be the page associated with the first icon of the icon group 211a, or a page associated with a random icon of the icon group 211a. Similarly, if the touch by the user is on the second preview region 22, and the gesture identifying module 32 identifies the type of the touch operation as sliding leftward, or holding an icon group and dragging the icon group out of the second preview region 22, that is, the user wants to move the current active icon group 211 displayed on the second preview region 22 onto the first preview region 21. This page processing function is similar to that of with moving the current active icon group 211 displayed on the first preview region 21 onto the second preview region 22 and the details are thus omitted.

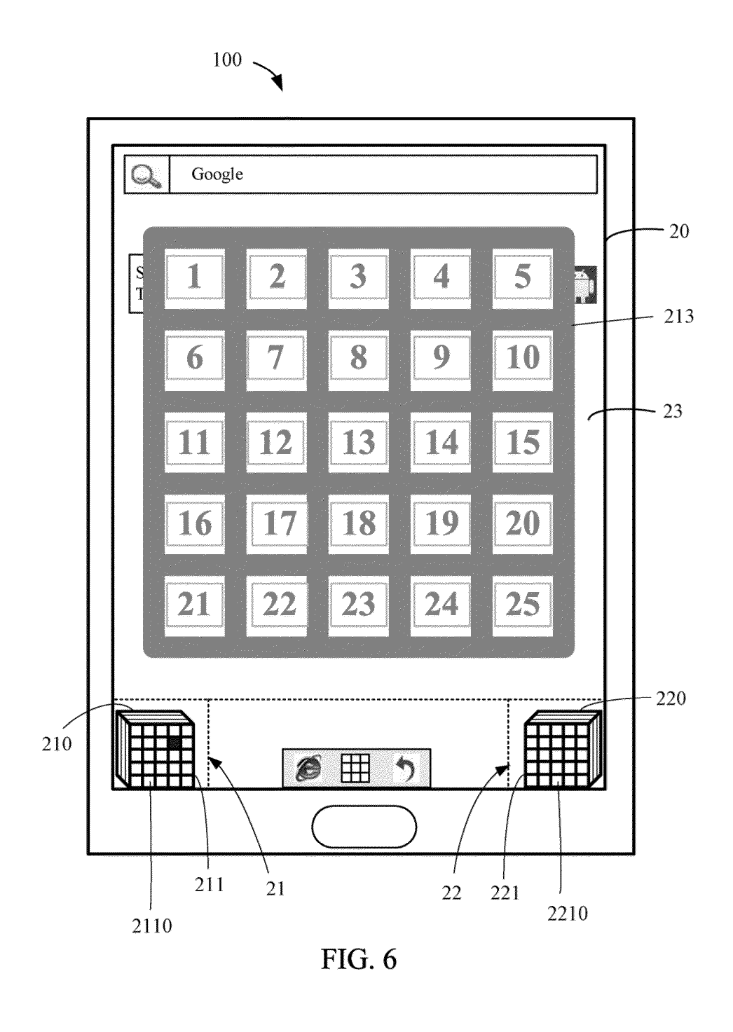

Referring back to FIG. 3, when the region confirming module 31 confirms the touch of the user is on the first preview region 21, and the gesture identifying module 32 identifies the type of the touch as being a short pressing on an icon group 211, that is, the user wants the icon group to be displayed on the page display region 23. The page processing module 33 determines that the relevant page processing function is to display the pressed icon group on the page display region 23, all according to the confirmed result, the identified result, and the function table 12, that is, the icon group is displayed as overlapping the currently displayed page on the page display region 23. The page processing module 33 further creates an icon group 213. The created icon group 213 is obtained by zooming in to the icon group 211 and then displaying the zoomed icon group 211 including the icon 2110, which is shown in FIG. 6. In this embodiment, the number displayed on each icon represents the page number of the page associated with the icon.

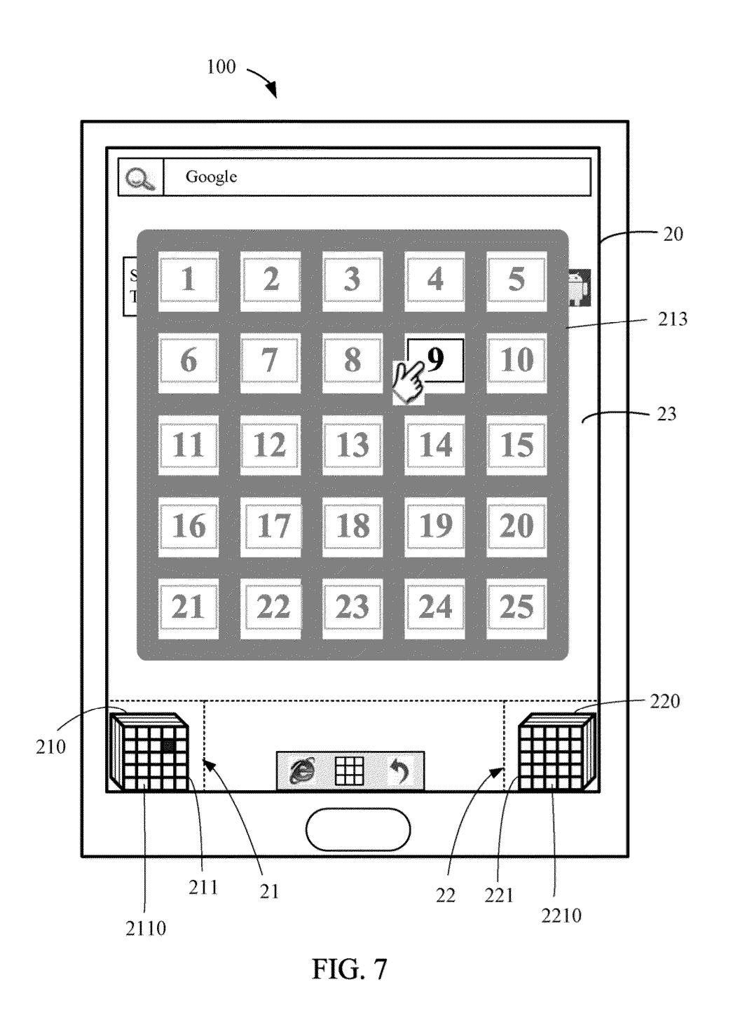

When the region confirming module 31 confirms that the touch region of the touch of the user is on the page display region 23, and the gesture identifying module 32 identifies the type of the touch as being a short pressing (eg. the time period of the touch operation is not more than 2 seconds) on an icon (eg. labeled with number 9) of an icon group, the page processing module 33 retrieves the page associated with the pressed icon. The display control module 34 displays the retrieved page under the icon group on the page display region 23, and highlights the icon associated with the retrieved page (see FIG. 7).

Referring back to FIG. 6, when the page display region 23 displays an icon group, the region confirming region 31 confirms that the touch of the user is on the page display region 23, and the gesture identifying module 32 identifies that the type of touch is a long pressing (eg. the time period of the touch operation is longer than 2 seconds) on an icon (eg. the icon labeled with number 9) of an icon group, the page processing module 33 retrieves the page associated with the pressed icon. The display control module 34 displays the page associated with the pressed icon on the page display region 23, and at the same time, cancels the display of the icon group, including the pressed icon, on the page display region 23.

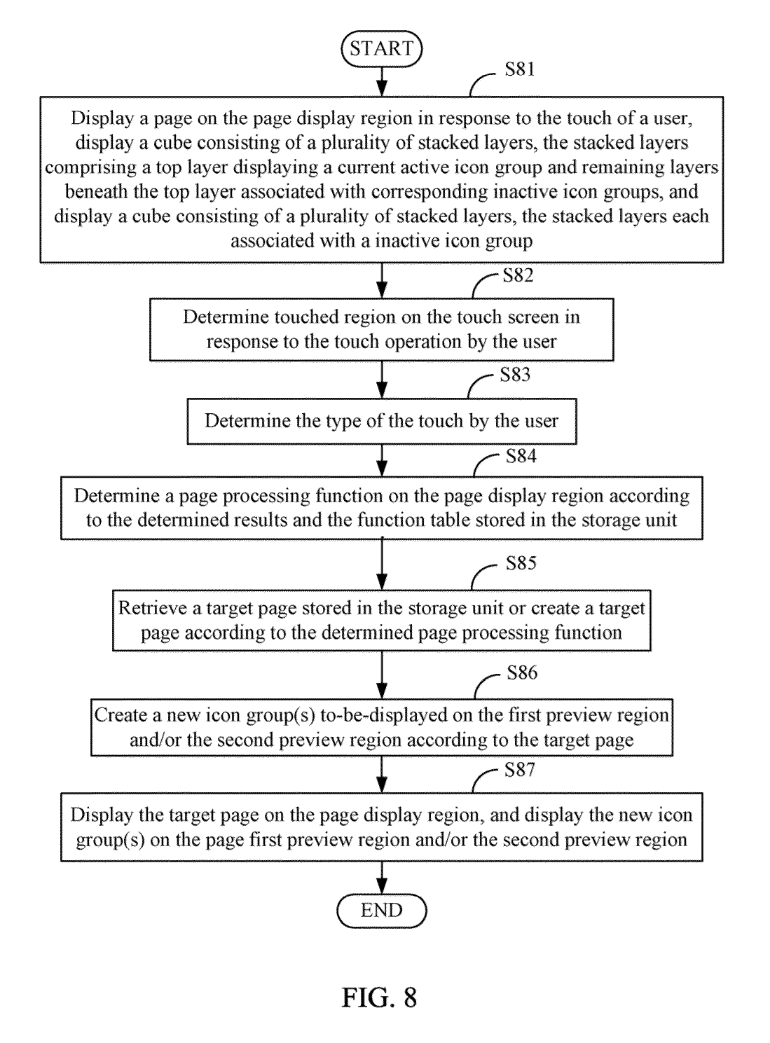

Referring to FIG. 8, a flowchart of a page processing method of the electronic device 100 of FIG. 1 is shown. The electronic device 100 includes a touch screen and a storage unit. The touch screen includes a first preview region, a second preview region, and a page display region. The storage unit stores at least one electronic file and a function table. The function table contains the relationships between the touched regions on the touch screen, a number of types of touches and a number of page processing functions on the page display region. The method includes the following steps, each of which is related to the various components contained in the electronic device 100.

In step S81, the touch screen 20 displays a page on the page display region 23 in response to the touch of a user, displays a cube 210 consisting of a plurality of stacked layers, the stacked layers comprising a top layer displaying a current active icon group and remaining layers beneath the top layer associated with corresponding inactive icon groups, and displays a cube 220 consisting of a plurality of stacked layers, the stacked layers each associated with a inactive icon group.

In step S82, the region confirming module 31 determines the touched region on the touch screen 20 in response to the touch operation by the user.

In step S83, the gesture identifying module 32 determines the type of the touch by the user. In this embodiment, the types of touches on the first preview region 21 are selected from the group consisting of: sliding rightward, holding an icon group and dragging the icon group beyond the first preview region 21, and a short pressing on an icon group. The predetermined types of touches on the second preview region 22 are selected from the group consisting of: sliding leftward, and holding an icon group and dragging the icon group beyond the second preview region 22. When the page display region 23 displays an icon group, the predetermined types of touches applied on the page display region 23 are selected from the group consisting of: a short pressing on an icon of an icon group, and a long pressing on an icon of an icon group.

In step S84, the page processing module 33 determines a page processing function on the page display region 23 according to the determined results transmitted from the region confirming module 31 and the gesture identifying module 32 and the function table 12 stored in the storage unit 10.

In step S85, the page processing module 33 retrieves a target page stored in the storage unit 10 or creates a target page according to the determined page processing function.

In step S86, the page processing module 33 creates a new icon group(s) to-be-displayed on the first preview region 21 and/or the second preview region 22 according to the target page.

In step S87, the display control module 34 displays the target page on the page display region 23, and displays the new icon group(s) on the page first preview region 21 and/or the second preview region 22.

The user can preview the icon group representing the displayed page and the pages adjacent to the displayed page on the first preview region 21 located at the bottom left of the touch screen 20, and slides a fingertip on the page display region 23 of the touch screen 20 for flipping to a desired page. The touch screen 20 will then display the desired page. The user can conveniently and accurately flip to any desired page, which improves the page flipping efficiency and saves the time of the user.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A page processing method for an electronic device having a touch screen and a storage unit, the touch screen comprising a first preview region, a second preview region, and a page display region, the storage unit storing an electronic file and a function table, the function table containing the relationships between the touched regions on the touch screen, types of touches and page processing functions on the page display region, the method comprising:
displaying a page on the page display region in response to the touch operation of a user,
displaying a first cube on the first preview region, the first cube consisting of a plurality of stacked layers, the stacked layers comprising a top layer displaying a current active icon group and remaining layers beneath the top layer associated with corresponding inactive icon groups,
displaying a second cube on the second preview region, the second cube consisting of a plurality of stacked layers, the stacked layers each associated with a inactive icon group, wherein each of the active and inactive icon groups comprises a plurality of icons arranged in an array and associated with a plurality of corresponding adjacent pages, and the current active icon group comprises a marked icon associated with a currently displayed page and a plurality of unmarked icons associated with a plurality of undisplayed pages adjacent to the currently displayed page;
determining touched region on the touch screen in response to the touch operation by the user;
determining the type of the touch by the user;
determining a page processing function on the page display region according to the type of the touch operation, the touched region, and the function table;
retrieving a target page stored in the storage unit or creating a target page according to the determined page processing function;
creating at least one new icon group according to the target page; and
displaying the target page on the page display region, and updating the icon groups of the first and second cubes.

2. The method as described in claim 1, wherein:
the types of touches applied on the first preview region are selected from the group consisting of: sliding rightward, holding an icon group and dragging the icon group beyond the first preview region, and a short press on an icon group;
the types of touches applied on the second preview region are selected from the group consisting of: sliding leftward, and holding an icon group and dragging the icon group beyond the second preview region; and
the types of touches applied on the page display region are selected from the group consisting of: a short press on an icon of an icon group, and a long pressing on an icon of an icon group.

3. The method as described in claim 2, further comprising switching the displayed page with effect pages on the page display region on conditions of:
the touch by the user being applied on the first preview region, and the type of the touch operation is sliding rightward, or holding an icon group and dragging the icon group beyond the first preview region; or
touch by the user is applied on the second preview region, and the type of the touch operation is sliding leftward or holding an icon group and dragging the icon group beyond the second preview region.

4. The method as described in claim 2, further comprising displaying the icon group with light color on the page display region if the touch by the user is applied on the first preview region, and the type of the touch operation is a short press on an icon group.

5. The method as described in claim 4, wherein if the touch by the user is applied on the page display region, and the type of the touch operation is a short press on an icon of an icon group, the method further comprises displaying the page associated with the pressed icon on the page display region, keeping displaying the icon group comprising the pressed icon with light color on the top layer of the page display region, and highlighting the pressed icon.

6. The method as described in claim 4, wherein if the touch by the user is applied on the page display region, and the type of the touch operation is a long pressing on an icon of an icon group, the method further comprises displaying the page associated with the pressed icon on the page display region, and eliminating the displayed icon group comprising the pressed icon with light color on the page display region.

7. An electronic device, comprising:
a touch screen, comprising a first preview region, a second preview region, and a page display region, the touch screen being configured for displaying a page on the page display region in response to the touch operation of a user, displaying a first cube on the first preview region, the first cube consisting of a plurality of stacked layers, the stacked layers comprising a top layer displaying a current active icon group and remaining layers beneath the top layer associated with corresponding inactive icon groups, and displaying a second cube on the second preview region, the second cube consisting of a plurality of stacked layers, the stacked layers each associated with a inactive icon group, wherein each of the active and inactive icon groups comprises a plurality of icons arranged in an array and associated with a plurality of corresponding adjacent pages, and the current active icon group comprises a marked icon associated with a currently displayed page and a plurality of unmarked icons associated with a plurality of undisplayed pages adjacent to the currently displayed page;
a storage unit storing an electronic file and a function table, the function table containing the relationships between the touched regions on the touch screen, type of touches and page processing functions on the page display region; and
a processor comprising:
a region confirming module, configured for determining touched region on the touch screen in response to the touch operation by the user;
a gesture identifying module, configure for determining the type of the touch by the user;
a page processing module, configured for determining a page processing function on the page display region according to the type of the touch operation, the touched region, and the function table, retrieving a target page stored in the storage unit or creating a target page according to the determined page processing function, and for creating at least one new icon group according to the target page; and
a display control module, configured for displaying the target page on the page display region, and updating the icon groups of the first and second cubes.

8. The electronic device as described in claim 7, wherein:
the types of touches applied on the first preview region are selected from the group consisting of: sliding rightward, holding an icon group and dragging the icon group beyond the first preview region, and a short press on an icon group;
the types of touches applied on the second preview region are selected from the group consisting of: sliding leftward, and holding an icon group and dragging the icon group beyond the second preview region; and
the types of touches applied on the page display region are selected from the group consisting of: a short press on an icon of an icon group, and a long pressing on an icon of an icon group.

9. The electronic device as described in claim 8, wherein the page processing function is switching the displayed page with effect pages on the page display region on conditions of:
the touch by the user being applied on the first preview region, and the type of the touch operation is sliding rightward, or holding an icon group and dragging the icon group beyond the first preview region; or
touch by the user is applied on the second preview region, and the type of the touch operation is sliding leftward or holding an icon group and dragging the icon group beyond the second preview region.

10. The electronic device as described in claim 8, wherein if the touch by the user is applied on the first preview region, and the type of the touch operation is a short press on an icon group, the corresponding page processing function is displaying the icon group with light color on the page display region.

11. The electronic device as described in claim 10, wherein if the touch by the user is applied on the page display region, and the type of the touch operation is a short press on an icon of an icon group, the corresponding page processing function is displaying the page associated with the pressed icon on the page display region, keeping displaying the icon group comprising the pressed icon with light color on the top layer of the page display region, and highlighting the pressed icon.

12. The electronic device as described in claim 10, wherein if the touch by the user is applied on the page display region, and the type of the touch operation is a long pressing on an icon of an icon group, the corresponding page processing function is displaying the page associated with the pressed icon on the page display region, and eliminating the displayed icon group comprising the pressed icon with light color on the page display region.
